(19) United States
(12) Patent Application Publication
(10) Pub. No.: US 2025/0242596 A1
(43) Pub. Date: Jul. 31, 2025

(54) HEAD CLEANER AND LIQUID DISCHARGE APPARATUS

(71) Applicant: Yuta KOBAYASHI, TOKYO (JP)

(72) Inventor: Yuta KOBAYASHI, TOKYO (JP)

(21) Appl. No.: 18/985,097

(22) Filed: Dec. 18, 2024

(30) Foreign Application Priority Data
Jan. 31, 2024 (JP) 2024-013727

(51) Int. Cl. B41J 2/165

(52) U.S. Cl. CPC B41J 2/16544

(57) ABSTRACT

A head cleaner cleans a nozzle face of a liquid discharge head. The head cleaner includes a wiper that wipes and cleans the nozzle face. The wiper includes a wiping portion that contacts and wipes the nozzle face. A flexible presser presses the wiping portion against the nozzle face. The flexible presser has a flexibility that is greater than a flexibility of the nozzle face. A support supports the wiper. A securing member secures the wiping portion to the flexible presser removably.

### CROSS-REFERENCE TO RELATED APPLICATION

This patent application is based on and claims priority pursuant to 35 U.S.C. § 119 (a) to Japanese Patent Application No. 2024-013727, filed on Jan. 31, 2024, in the Japan Patent Office, the entire disclosure of which is hereby incorporated by reference herein.

### BACKGROUND

### Technical Field

Embodiments of this disclosure relate to a head cleaner and a liquid discharge apparatus, and more particularly, to a head cleaner and a liquid discharge apparatus incorporating the head cleaner.

### Related Art

Related-art image forming apparatuses, such as copiers, facsimile machines, printers, and multifunction peripherals (MFP) having two or more of copying, printing, scanning, facsimile, plotter, and other functions, typically form an image on a recording medium according to image data.

Such image forming apparatuses include a head cleaner that includes a wiper supported by a support. The wiper wipes a nozzle face of a liquid discharge head, cleaning the nozzle face.

### SUMMARY

This specification describes below an improved head cleaner. In one embodiment, the head cleaner cleans a nozzle face of a liquid discharge head. The head cleaner includes a wiper that wipes and cleans the nozzle face. The wiper includes a wiping portion that contacts and wipes the nozzle face. A flexible presser presses the wiping portion against the nozzle face. The flexible presser has a flexibility that is greater than a flexibility of the nozzle face. A support supports the wiper. A securing member secures the wiping portion to the flexible presser removably.

This specification further describes an improved head cleaner. In one embodiment, the head cleaner cleans a nozzle face of a liquid discharge head. The head cleaner includes a wiper that wipes and cleans the nozzle face. A support supports the wiper. The wiper includes a first wiping portion that contacts and wipes the nozzle face. A second wiping portion is removably attached with the first wiping portion. A flexible presser presses the first wiping portion and the second wiping portion against the nozzle face. The flexible presser has a flexibility that is greater than a flexibility of the nozzle face. The first wiping portion peels off from the second wiping portion.

This specification further describes an improved liquid discharge apparatus. In one embodiment, the liquid discharge apparatus includes a liquid discharge head having a nozzle face that discharges liquid and the head cleaner described above that cleans the nozzle face.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a side cross-sectional view of a printer according to a first embodiment of the present disclosure;

FIG. 2 is a front view of the printer depicted in FIG. 1;

FIG. 3 is a plan view of the printer depicted in FIG. 2;

FIG. 4 is a perspective view of a head cleaner incorporated in the printer depicted in FIG. 3;

FIG. 5 is a perspective view of a cleaner body of the head cleaner depicted in FIG. 4;

FIG. 6 is a cross-sectional view of a wiper incorporated in the cleaner body depicted in FIG. 5, illustrating a flexible presser of the wiper;

FIG. 7 is a plan view of the wiper depicted in FIG. 6;

FIG. 8A is a diagram of the head cleaner, illustrating a first process of replacing a wiper sheet of the wiper depicted in FIG. 6;

FIG. 8B is a diagram of the head cleaner, illustrating a second process of replacing the wiper sheet of the wiper depicted in FIG. 6;

FIG. 8C is a diagram of the head cleaner, illustrating a third process of replacing the wiper sheet of the wiper depicted in FIG. 6;

FIG. 9A is a perspective view of the printer depicted in FIG. 1, illustrating a first process of installing the head cleaner into the printer;

FIG. 9B is a perspective view of the printer depicted in FIG. 1, illustrating a second process of installing the head cleaner into the printer;

FIG. 10 is a cross-sectional view of a flexible presser as a modification example of the flexible presser depicted in FIG. 6;

FIG. 11 is a perspective view of a cleaner body of a head cleaner according to a second embodiment of the present disclosure;

FIG. 12 is a cross-sectional view of a wiper incorporated in the cleaner body depicted in FIG. 11;

FIG. 13A is a cross-sectional view of a head cleaner as a modification example of the head cleaner depicted in FIG. 11 before the head cleaner is lifted; and

FIG. 13B is a cross-sectional view of the head cleaner depicted in FIG. 13A after the head cleaner is lifted.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

The following describes embodiments applied to a head cleaner that cleans a nozzle face of a liquid discharge head installed in a printer serving as a liquid discharge apparatus that discharges liquid.

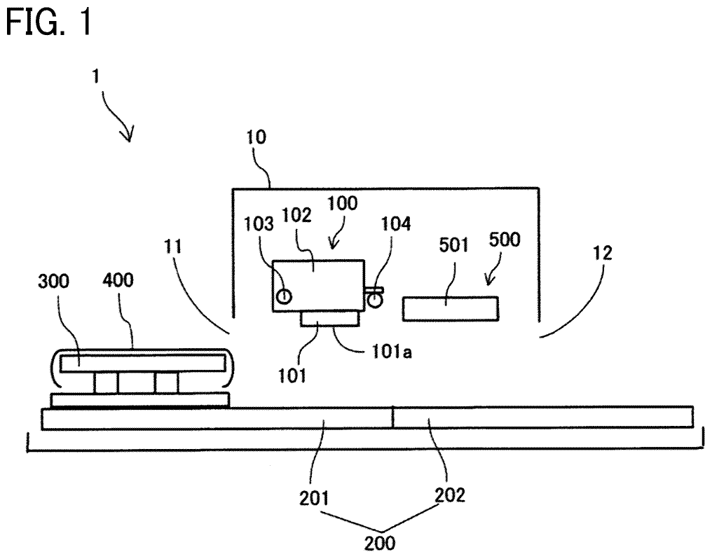

Referring to FIGS. 1 to 3, a description is provided of a construction of a printer 1 according to a first embodiment of the present disclosure.

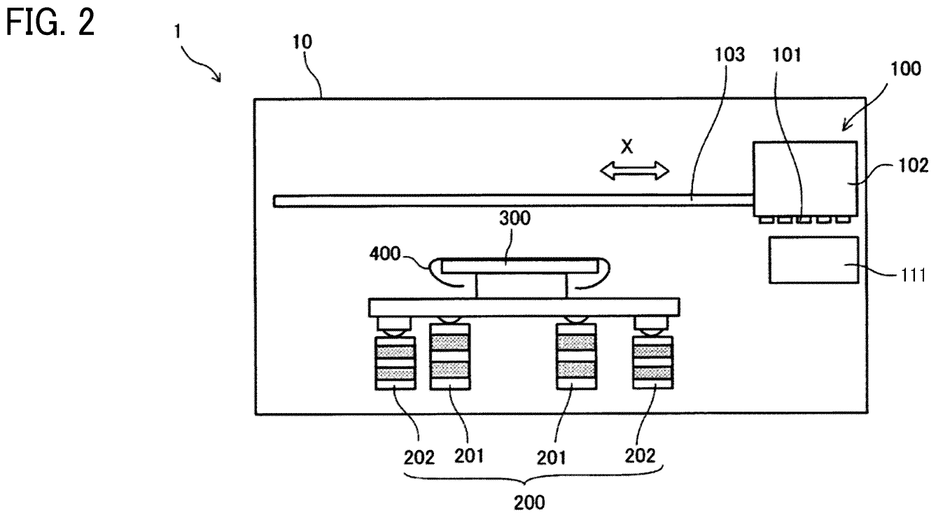

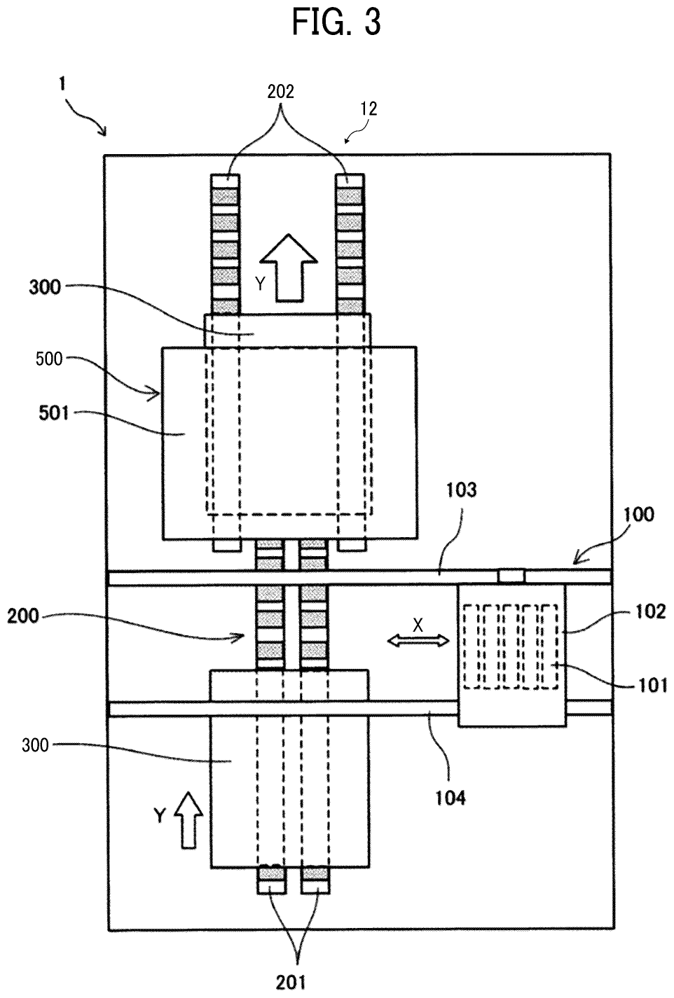

FIG. 1 is a side cross-sectional view of the printer 1 according to the first embodiment. FIG. 2 is a front view of the printer 1 according to the first embodiment. FIG. 3 is a plan view of the printer 1 according to the first embodiment.

The printer 1 according to the first embodiment includes an apparatus body 10, a printing portion 100, a tray 300, cloth 400, and a heating portion 500. The apparatus body 10 accommodates the printing portion 100 and the heating portion 500. The printing portion 100 prints on the cloth 400 serving as a print target held by the tray 300 serving as a holder. The heating portion 500 heats the cloth 400 printed by the printing portion 100.

The printing portion 100 includes one or more liquid discharge heads 101 that discharge liquid and a carriage 102 that mounts the liquid discharge heads 101. For example, the carriage 102 mounts five liquid discharge heads 101 that discharge cyan (C) ink, magenta (M) ink, yellow (Y) ink, black (K) ink, and white ink, respectively. The printing portion 100 further includes a main guide 103 and a sub guide 104 that serve as guides that guide the carriage 102 that moves reciprocatingly in a main scanning direction X depicted in FIG. 2.

The heating portion 500 includes a heater 501, for example. The heater 501 is a warm air dryer, a heating plate that contacts and presses against the cloth 400, a heating plate that does not contact the cloth 400, or the like, thus heating the cloth 400.

The printer 1 further includes a conveying portion 200. The apparatus body 10 further includes an inlet 11 and an outlet 12. The conveying portion 200 defines a conveyance path through which the tray 300 enters the inlet 11 of the apparatus body 10, travels below the printing portion 100 and the heating portion 500, and exits from the outlet 12 of the apparatus body 10. For example, the conveying portion 200 includes a timing belt, a conveyor, or the like. The conveying portion 200 includes a first conveyor 201 and a second conveyor 202. As illustrated in FIG. 3, the first conveyor 201 conveys the tray 300 in a sub-scanning direction Y in a state in which the tray 300 is disposed opposite the printing portion 100. The second conveyor 202 conveys the tray 300 in the sub-scanning direction Y in a state in which the tray 300 is disposed opposite the heating portion 500.

The tray 300 removably holds the cloth 400, such as a T-shirt, that serves as the print target (e.g., a liquid application target to be applied with liquid). Alternatively, instead of the tray 300, the holder may be a cassette as long as the holder holds the print target.

The printer 1 further includes a maintenance unit 111 including a cap that caps a nozzle face 101a (e.g., a face of a nozzle plate) of the liquid discharge head 101. The maintenance unit 111 is disposed opposite the carriage 102 situated at a home position as illustrated in FIG. 2.

A description is provided of a construction of a head cleaner 600 according to the first embodiment.

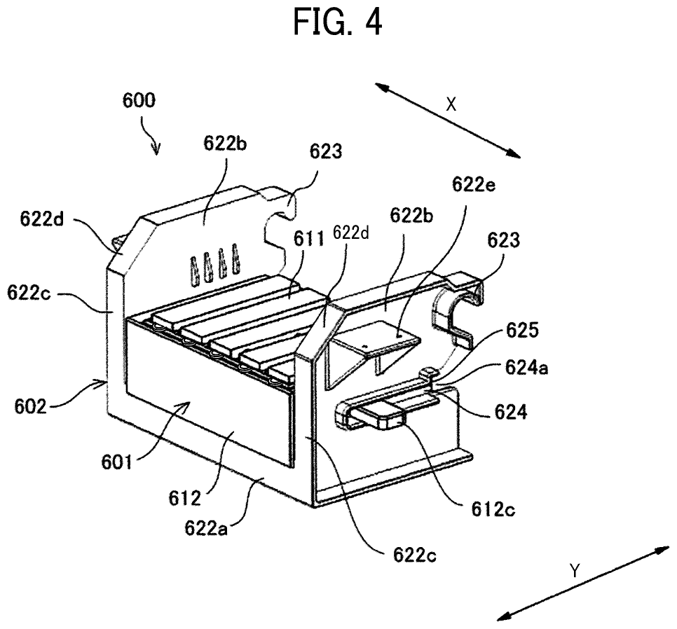

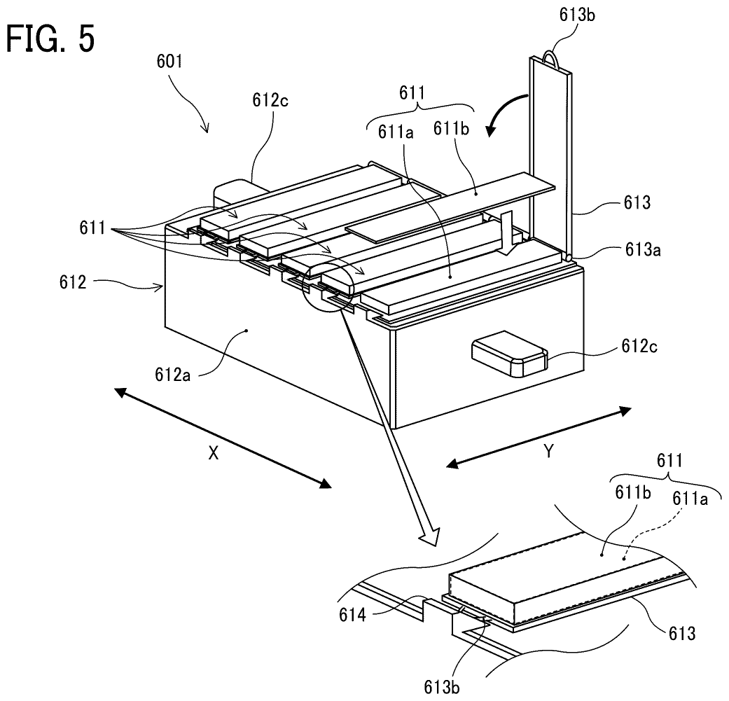

FIG. 4 is a perspective view of the head cleaner 600 according to the first embodiment. FIG. 5 is a perspective view of a cleaner body 601 of the head cleaner 600 according to the first embodiment.

As illustrated in FIG. 4, the head cleaner 600 includes the cleaner body 601 and a holder 602 that movably holds the cleaner body 601. The cleaner body 601 includes a wiper 611 and a slider 612 serving as a support that supports the wiper 611.

As illustrated in FIG. 5, the slider 612 includes a slider body 612a that has a box shape. The slider body 612a mounts and holds a plurality of wipers 611. The slider 612 further includes projections 612c that are mounted on outer faces of the slider body 612a, respectively. The projections 612c serve as catches that are manually operated by a user. In the head cleaner 600 according to the first embodiment, the plurality of wipers 611 is placed on the slider 612.

For example, the wipers 611 are disposed opposite the liquid discharge heads 101 or nozzles that are arranged in a row and discharge the cyan ink, the magenta ink, the yellow ink, the black ink, and the white ink, respectively.

As illustrated in FIG. 4, the holder 602 movably holds the cleaner body 601. The holder 602 is mainly constructed of a bottom 622a and side plates 622b that abut on both sides of the bottom 622a, respectively. The holder 602 further includes hooks 623 that are mounted on the side plates 622b, respectively. The hooks 623 are hooked on the main guide 103 of the printer 1 depicted in FIG. 3. The hooks 623 serve as one example of couplers that removably couple the head cleaner 600 with the main guide 103.

The holder 602 further includes guides 624 that penetrate through the side plates 622b, respectively. Each of the guides 624 is a groove that movably guides the projection 612c of the slider 612 of the cleaner body 601 in the sub-scanning direction Y in which the cleaner body 601 moves. The guide 624 includes a mouth 624a (e.g., an opening) that is disposed at one end of the guide 624, for example, an end of the guide 624 in the sub-scanning direction Y, that mounts the hook 623. The projection 612c is inserted into and removed from the guide 624 through the mouth 624a.

The holder 602 further includes stoppers 625 that are mounted on the mouths 624a of the guides 624, respectively. Each of the stoppers 625 is constructed of an elastic member or a combination of a resin member and a spring. As the stopper 625 is caught by the projection 612c of the cleaner body 601, that is placed in the guide 624, the stopper 625 prevents the cleaner body 601 from separating from the holder 602 easily.

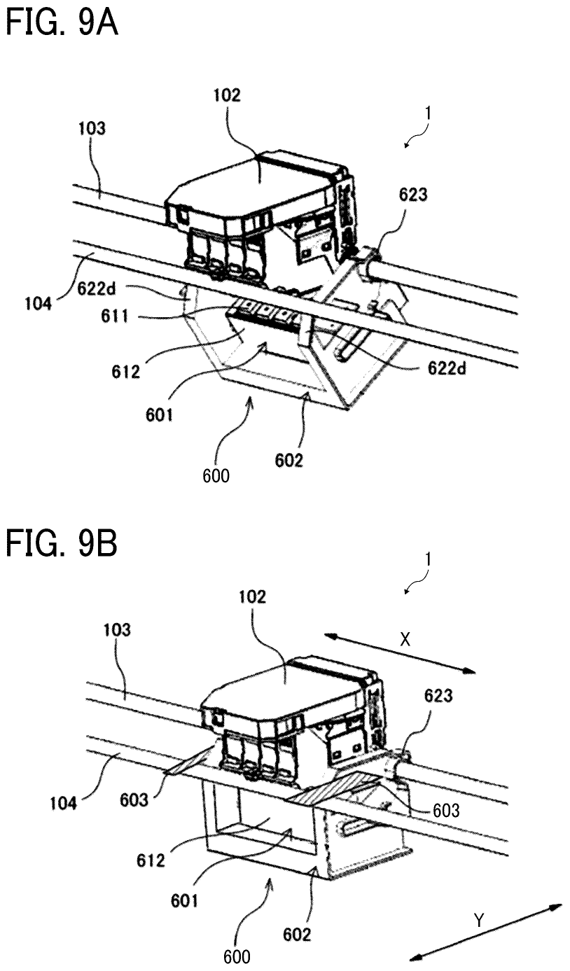

The holder 602 further includes walls 622c that are disposed in proximity to another ends of the guides 624 in the sub-scanning direction Y, respectively. For example, the walls 622c are disposed at another ends of the side plates 622b, that are opposite to one ends of the side plates 622b, that mount the hooks 623, in the sub-scanning direction Y, respectively. The holder 602 further includes slopes 622d serving as chamfers that are disposed on corners of the side plates 622b, respectively. For example, each of the slopes 622d is mounted on one end of an upper face of the side plate 622b, that is opposite to another end of the upper face of the side plate 622b, that mounts the hook 623, in the sub-scanning direction Y. The holder 602 further includes securing plate mounts 622e that are mounted on the side plates 622b, respectively. Each of the securing plate mounts 622e is attached with a securing plate 603 described below with reference to FIG. 9B.

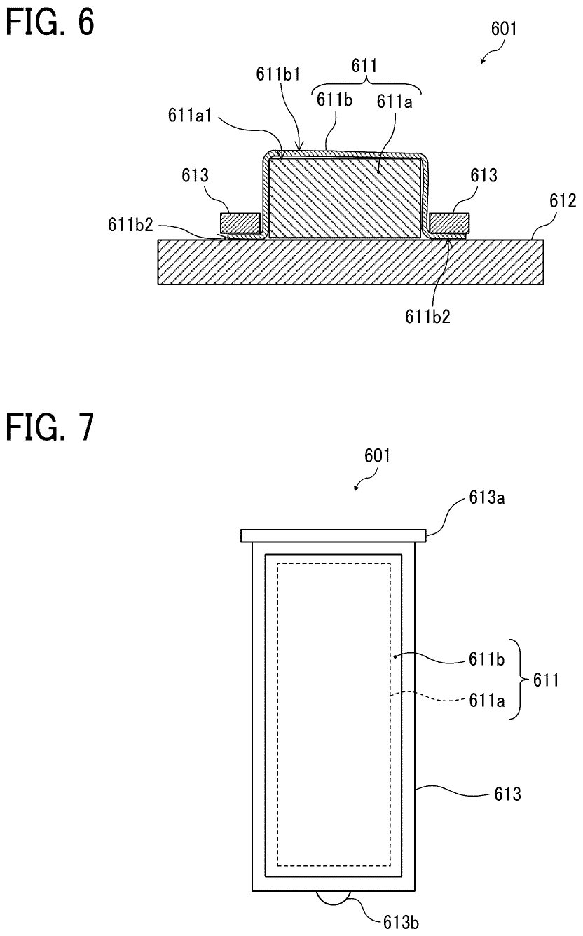

FIG. 6 is a cross-sectional view of the wiper 611 according to the first embodiment. FIG. 7 is a plan view of the wiper 611 according to the first embodiment.

The wiper 611 of the cleaner body 601 according to the first embodiment includes a wiper sheet 611b and a flexible presser 611a. The wiper sheet 611b is a wiper in a sheet form and serves as a wiping portion that wipes the nozzle face 101a of the liquid discharge head 101. The flexible presser 611a presses the wiper sheet 611b against the nozzle face 101a of the liquid discharge head 101.

The wiper sheet 611b of the wiper 611 contacts and wipes the nozzle face 101a of the liquid discharge head 101. The wiper sheet 611b achieves cleaning performance such as improved water absorption for absorbing liquid and the like on the nozzle face 101a and cleaning the nozzle face 101a and improved wiping for wiping the nozzle face 101a mechanically. Additionally, the wiper sheet 611b achieves improved flexibility for deforming with the flexible presser 611a and decreasing pressure with which the wiper sheet 611b presses against the nozzle face 101a. The wiper sheet 611b is preferably the wiper in the sheet form, that covers a pressing face 611al of the flexible presser 611a and has a thickness smaller than a thickness of the flexible presser 611a. For example, the wiper sheet 611b is a sheet made of fabric such as cleaning cloth (e.g., rag) and non-woven fabric, paper, or the like.

The wiper sheet 611b has a wiping face 611b1 and a back face that is opposite to the wiping face 611b1. The pressing face 611al of the flexible presser 611a of the wiper 611 supports the back face of the wiper sheet 611b, pressing the wiping face 611b1 of the wiper sheet 611b against the nozzle face 101a. The flexible presser 611a is made of a material that is more flexible than a material of the nozzle face 101a. Thus, the flexible presser 611a attains flexibility to deform, thus decreasing pressure with which the wiper sheet 611b supported by the flexible presser 611a contacts the nozzle face 101a. The flexible presser 611a is preferably made of a soft material having sufficient flexibility, for example, a porous material such as rubber and sponge.

After the wiper 611 is used, the wiping face 611b1 of the wiper sheet 611b may be adhered with stains (e.g., liquid) from the nozzle face 101a. Hence, if the wiper 611 is used again, the wiper 611 adhered with the stains may stain the nozzle face 101a. Accordingly, in order to retain a proper condition of the printer 1, the wiper 611 is preferably replaced with new one once the wiper 611 is used. However, a comparative wiper is entirely replaced with new one, increasing costs for replacement parts that are replaced and maintenance costs of the printer 1.

According to the first embodiment, the wiper 611 placed on and supported by the slider 612 is divided into the wiper sheet 611b serving as a wiping portion and the flexible presser 611a. The wiper sheet 611b is replaced with respect to the flexible presser 611a. Accordingly, the flexible presser 611a having a sufficient thickness attains flexibility that causes the wiper sheet 611b to wipe the nozzle face 101a without damaging the nozzle face 101a. The wiper sheet 611b adhered with stains from the nozzle face 101a after the wiper sheet 611b wipes the nozzle face 101a is replaced with new one as a replacement part. Consequently, compared to a configuration in which an entirety of the wiper 611 is replaced with a replacement part, the wiper 611 according to the first embodiment reduces costs for replacement parts and suppresses maintenance costs of the printer 1.

The flexible presser 611a according to the first embodiment is mounted on and combined with the slider 612. Alternatively, the flexible presser 611a may be replaced with respect to the slider 612. The flexible presser 611a is replaced with new one less frequently than the wiper sheet 611b, suppressing maintenance costs of the printer 1.

A description is provided of processes for replacing the wiper sheet 611b as a replacement part.

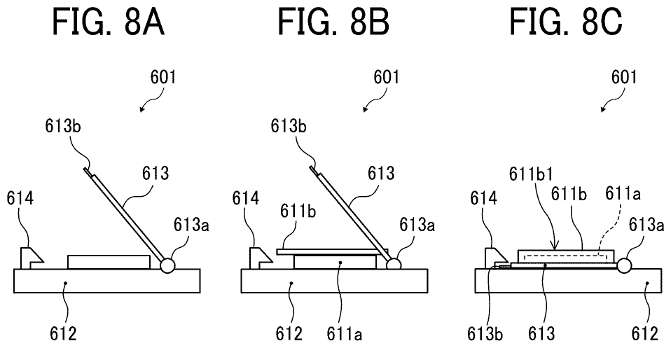

FIGS. 8A, 8B, and 8C illustrate the processes for replacing the wiper sheet 611b, respectively.

The cleaner body 601 according to the first embodiment includes a sheet holder 613 serving as a securing member that secures the wiper sheet 611b to the flexible presser 611a of the wiper 611 such that the wiper sheet 611b is replaceable.

As illustrated in FIG. 6, the wiper sheet 611b includes extensions 611b2 that extend outboard from the pressing face 611al of the flexible presser 611a. The sheet holder 613 switches between a securing state and a replacement state. In the securing state, the sheet holder 613 presses the extensions 611b2 against the slider 612, securing the extensions 611b2 to the slider 612. In the replacement state, the sheet holder 613 releases pressure applied to the extensions 611b2 so that the wiper sheet 611b is replaced.

For example, as illustrated in FIGS. 8A, 8B, and 8C, the cleaner body 601 further includes a hinge 613a that is mounted on the slider 612 serving as the support. The sheet holder 613 is supported by the slider 612 such that the sheet holder 613 pivots about the hinge 613a. The hinge 613a is disposed at one end of the wiper 611 in a longitudinal direction thereof. As illustrated in FIG. 7, the sheet holder 613 is a rectangular frame and includes a center aperture (e.g., an opening) that is disposed at a center of the sheet holder 613. The wiping face 611b1 of the wiper 611 is exposed through the center aperture.

FIGS. 8A and 8B illustrate the replacement state in which the sheet holder 613 pivots about the hinge 613a and opens such that the sheet holder 613 separates from the wiper 611. FIG. 8C illustrates the securing state in which the sheet holder 613 pivots about the hinge 613a and closes. FIG. 5 illustrates the replacement state of the rightmost wiper 611 in FIG. 5 of the five wipers 611 placed on and supported by the slider 612. The sheet holder 613 is lifted and opened with respect to the rightmost wiper 611. FIG. 5 illustrates the securing state of the four wipers 611 other than the rightmost wiper 611. The sheet holders 613 are lowered and closed with respect to the four wipers 611, respectively.

According to the first embodiment, in order to attach the wiper sheet 611b, as illustrated in FIG. 8A, the user opens the sheet holder 613. As illustrated in FIG. 8B, the user places the wiper sheet 611b such that the wiper sheet 611b covers the pressing face 611al of the flexible presser 611a that is not covered by the wiper sheet 611b. Thereafter, the user closes the sheet holder 613. Accordingly, the flexible presser 611a covered with the wiper sheet 611b is embedded in the center aperture of the sheet holder 613. The sheet holder 613 presses the extensions 611b2 of the wiper sheet 611b, that extend outboard from the pressing face 611al of the flexible presser 611a depicted in FIG. 6.

As illustrated in FIG. 5, the sheet holder 613 includes a stopped portion 613b that is disposed at a top end of the sheet holder 613, that is, an end opposite to another end at which the hinge 613a is disposed. The slider 612 mounts a stopper 614. The user closes the sheet holder 613 until the stopped portion 613b engages the stopper 614. Accordingly, the sheet holder 613 does not pivot about the hinge 613a. As illustrated in FIG. 8C, the sheet holder 613 is locked in the securing state. In the securing state, the wiping face 611b1 of the wiper sheet 611b, that covers the flexible presser 611a, is exposed beyond the center aperture of the sheet holder 613. The wiping face 611b1 of the wiper sheet 611b contacts and wipes the nozzle face 101a of the liquid discharge head 101.

Conversely, in order to remove the wiper sheet 611b that is stained after the wiper sheet 611b cleans the nozzle face 101a, the stopped portion 613b of the sheet holder 613 disengages the stopper 614 mounted on the slider 612. Thus, the sheet holder 613 is unlocked. Thereafter, the user pivots the sheet holder 613 about the hinge 613a and opens the sheet holder 613. Thus, the wiper sheet 611b is replaceable as illustrated in FIG. 8B. The user removes the wiper sheet 611b that covers the flexible presser 611a as illustrated in FIG. 8A. Thereafter, the new wiper sheet 611b is attached to the flexible presser 611a according to the processes described above.

A description is provided of a head cleaning method for cleaning the liquid discharge head 101, that is performed by the head cleaner 600 according to the first embodiment.

In order to clean the liquid discharge head 101 with the head cleaner 600, as illustrated in FIG. 9A, the hooks 623 of the holder 602 of the head cleaner 600 are hooked on and coupled with the main guide 103. As illustrated in FIG. 9B, the holder 602 pivots about the main guide 103 to bring the wiper 611 of the cleaner body 601 into contact with the nozzle face 101a of the liquid discharge head 101.

As the securing plate 603 is attached to the securing plate mounts 622e depicted in FIG. 4, the head cleaner 600 is secured to the main guide 103 and the sub guide 104. According to the first embodiment, the head cleaner 600 is secured to the sub guide 104 through the securing plate mounts 622e and the securing plate 603. Alternatively, the head cleaner 600 may be secured to the sub guide 104 with other configuration. For example, the head cleaner 600 may be secured to the sub guide 104 with a magnet or snap-fit.

The holder 602 according to the first embodiment includes the slopes 622d depicted in FIG. 9A. Hence, in a process for securing the head cleaner 600 to the sub guide 104 depicted in FIG. 9A and a subsequent process depicted in FIG. 9B, a part of the holder 602 does not contact the sub guide 104. Additionally, as illustrated in FIG. 4, the walls 622c are disposed in proximity to another ends of the guides 624, that are opposite to one ends of the guides 624, that mount the hooks 623, in the sub-scanning direction Y, respectively. Hence, in the process for securing the head cleaner 600 to the sub guide 104 depicted in FIG. 9A and the subsequent process depicted in FIG. 9B, the walls 622c prevent the holder 602 from dropping by weight.

According to the first embodiment, the user catches the projections 612c of the slider 612 of the cleaner body 601 depicted in FIG. 4 and manually moves the slider 612 along the guides 624 in the sub-scanning direction Y. Accordingly, the wipers 611 of the cleaner body 601 move relative to the nozzle faces 101a of the liquid discharge heads 101, wiping and cleaning the nozzle faces 101a, respectively. Thus, the head cleaner 600 cleans the nozzle faces 101a oriented downward readily.

According to the first embodiment, the cleaner body 601 incorporates a plurality of wipers 611, that is disposed opposite a plurality of liquid discharge heads 101. Accordingly, the wipers 611 wipe and clean a plurality of nozzle faces 101a of the plurality of liquid discharge heads 101 at a time. Thus, the wipers 611 clean the liquid discharge heads 101 in a shortened cleaning time.

The holder 602 of the head cleaner 600 mounts a driver and a driving mechanism that move the slider 612 reciprocatingly so that the wipers 611 of the cleaner body 601 automatically wipe the nozzle faces 101a of the liquid discharge heads 101, respectively.

Materials and shapes of the wipers 611 are different between the liquid discharge head 101 that discharges color liquid and the liquid discharge head 101 that discharges white liquid. Thus, the wipers 611 clean the liquid discharge heads 101 effectively according to the color liquid and the white liquid that stain the liquid discharge heads 101 and are removed from the liquid discharge heads 101 differently.

According to the first embodiment, the guides 624 extend in the sub-scanning direction Y. Hence, the wipers 611 also move in the sub-scanning direction Y. Alternatively, the guides 624 may extend in the main scanning direction X so that the wipers 611 move in the main scanning direction X. Yet alternatively, the wipers 611 may move in the main scanning direction X and the sub-scanning direction Y.

According to the first embodiment, in order to remove stains adhered to the liquid discharge head 101, the wiper 611 may be impregnated with a cleaning solution. The wiper sheet 611b as a replacement part may be impregnated with the cleaning solution. The flexible presser 611a as a non-replacement part may be impregnated with the cleaning solution and may supply the cleaning solution to the new wiper sheet 611b that is replaced.

According to the first embodiment, the pressing face 611al of the flexible presser 611a of the wiper 611 is planar. Alternatively, a pressing face having irregularities may be employed. For example, FIG. 10 illustrates a head cleaner 600A that includes a wiper 611A including a flexible presser 611aA having a pressing face 611a1A. The pressing face 611a1A of the flexible presser 611aA includes projections 611p and depressions 611d. The projections 611p locally contact and press against the wiper sheet 611b with increased pressure, causing the wiper sheet 611b to scrape stains from the nozzle face 101a of the liquid discharge head 101. Thus, the pressing face 611a1A improves cleaning performance of the head cleaner 600A.

A description is provided of other embodiments applied to a head cleaner that cleans a nozzle face of a liquid discharge head installed in a printer serving as a liquid discharge apparatus that discharges liquid.

A description is now given of a construction of a head cleaner 600B according to a second embodiment of the present disclosure.

The head cleaner 600B according to the second embodiment has a construction that is shared with the head cleaner 600 according to the first embodiment described above.

Hence, the following mainly describes a construction of the head cleaner 600B, that is different from the construction of the head cleaner 600 described above.

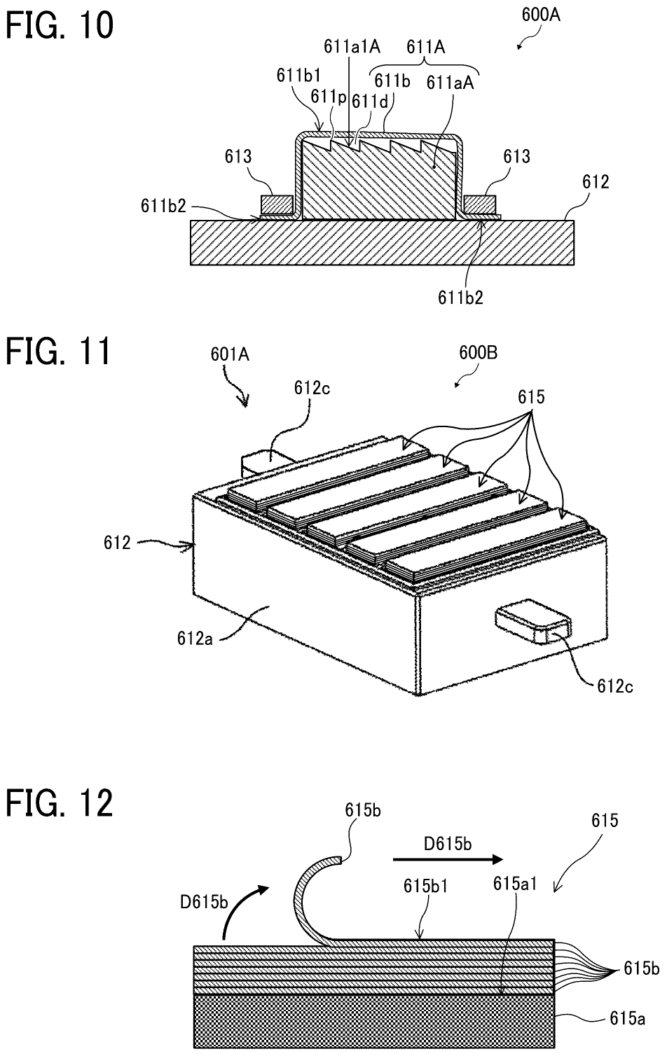

FIG. 11 is a perspective view of the head cleaner 600B according to the second embodiment, illustrating a cleaner body 601A thereof.

The head cleaner 600B according to the second embodiment has a basic construction that is shared with the head cleaner 600 according to the first embodiment described above. However, the head cleaner 600B includes a wiper 615 incorporated in the cleaner body 601A. The wiper 615 has a construction that is different from the construction of the wiper 611 according to the first embodiment.

FIG. 12 is a cross-sectional view of the wiper 615 according to the second embodiment.

According to the second embodiment, the wiper 615 of the cleaner body 601A includes a plurality of wiper sheets 615b and a flexible presser 615a. The wiper sheets 615b serve as wiping portions or wipers in a sheet form, respectively. The flexible presser 615a presses the wiper sheets 615b against the nozzle face 101a of the liquid discharge head 101.

The wiper sheet 615b of the wiper 615 contacts and wipes the nozzle face 101a of the liquid discharge head 101. Hence, like the wiper sheet 611b according to the first embodiment, the wiper sheet 615b achieves cleaning performance such as improved water absorption for absorbing liquid on the nozzle face 101a and improved wiping for wiping the nozzle face 101a. Additionally, the wiper sheet 615b achieves improved flexibility for deforming with the flexible presser 615a and decreasing pressure with which the wiper sheet 615b presses against the nozzle face 101a. For example, like the wiper sheet 611b according to the first embodiment, the wiper sheet 615b is a sheet made of fabric such as cleaning cloth (e.g., rag) and non-woven fabric, paper, or the like.

The wiper sheet 615b has a wiping face 615b1 and a back face that is opposite to the wiping face 615b1. The flexible presser 615a of the wiper 615 has a pressing face 615al that supports the back face of the wiper sheet 615b, pressing the wiping face 615b1 of the wiper sheet 615b against the nozzle face 101a. Like the flexible presser 611a according to the first embodiment, the flexible presser 615a is made of a material that is more flexible than a material of the nozzle face 101a. Thus, the flexible presser 615a attains flexibility to deform, decreasing pressure with which the wiper sheet 615b supported by the flexible presser 615a contacts the nozzle face 101a. Like the flexible presser 611a according to the first embodiment, the flexible presser 615a is preferably made of a soft material having sufficient flexibility, for example, a porous material such as rubber and sponge.

As illustrated in FIG. 12, the plurality of wiper sheets 615b according to the second embodiment is mounted and layered on the pressing face 615al of the flexible presser 615a. Accordingly, when the head cleaner 600B performs cleaning, an uppermost wiper sheet 615b of the plurality of wiper sheets 615b layered on the pressing face 615al contacts and wipes the nozzle face 101a of the liquid discharge head 101. Hence, the uppermost wiper sheet 615b is adhered with stains from the nozzle face 101a while the head cleaner 600B performs cleaning.

According to the second embodiment, an upper wiper sheet 615b is separably attached to other wiper sheet 615b disposed immediately below the upper wiper sheet 615b with an adhesive or the like. As illustrated in FIG. 12, after the head cleaner 600B performs cleaning, the user catches an end of the uppermost wiper sheet 615b and peels off the uppermost wiper sheet 615b from the clean wiper sheet 615b disposed immediately below the uppermost wiper sheet 615b in a peeling direction D615b. Accordingly, the user removes the uppermost wiper sheet 615b that is stained, exposing the clean wiper sheet 615b as an uppermost wiper sheet.

According to the second embodiment, like the first embodiment, the flexible presser 615a having a sufficient thickness attains flexibility that causes the wiper sheet 615b to wipe the nozzle face 101a without damaging the nozzle face 101a. The wiper sheet 615b adhered with stains from the nozzle face 101a after the wiper sheet 615b wipes the nozzle face 101a is replaced with new one as a replacement part. Consequently, compared to a configuration in which an entirety of the wiper 615 is replaced with new one as a replacement part, the wiper 615 according to the second embodiment also reduces costs for replacement parts and suppresses maintenance costs of the printer 1.

The head cleaner 600B according to the second embodiment eliminates the sheet holder 613 according to the first embodiment, that secures the wiper sheet 611b to the flexible presser 611a such that the wiper sheet 611b is replaceable. Hence, the head cleaner 600B has a simple construction.

Additionally, according to the second embodiment, as the user simply peels off the uppermost wiper sheet 615b, the user removes the stained wiper sheet 615b and sets the clean wiper sheet 615b at a time. Thus, the head cleaner 600B attains a process for replacing the wiper sheet 615b with new one, that is simpler than processes for replacing the wiper sheet 611b with new one, that are performed by the head cleaner 600 according to the first embodiment.

Each of the head cleaner 600 according to the first embodiment, the head cleaner 600A as a modification example of the head cleaner 600, and the head cleaner 600B according to the second embodiment is removably coupled with a liquid discharge apparatus (e.g., the printer 1). Alternatively, each of the head cleaners 600, 600A, and 600B may be installed in the liquid discharge apparatus. For example, when the head cleaner 600, 600A, or 600B performs cleaning, the carriage 102 moves to a predetermined head cleaning position (e.g., an opposed position where the carriage 102 is disposed opposite and above the head cleaner 600, 600A, or 600B). A driver lifts the head cleaner 600, 600A, or 600B toward the carriage 102, bringing the wiper 611, 611A, or 615 of the cleaner body 601 or 601A into contact with the nozzle face 101a of the liquid discharge head 101.

According to the second embodiment, a height of the wiper 615 varies depending on a number of the wiper sheets 615b that are layered. Accordingly, in a case that the driver lifts the head cleaner 600B to bring the wiper 615 into contact with the nozzle face 101a of the liquid discharge head 101, pressure with which the wiper 615 contacts the nozzle face 101a of the liquid discharge head 101 varies depending on the height of the wiper 615. Hence, the uppermost wiper sheet 615b preferably contacts the nozzle face 101a of the liquid discharge head 101 with predetermined pressure constantly.

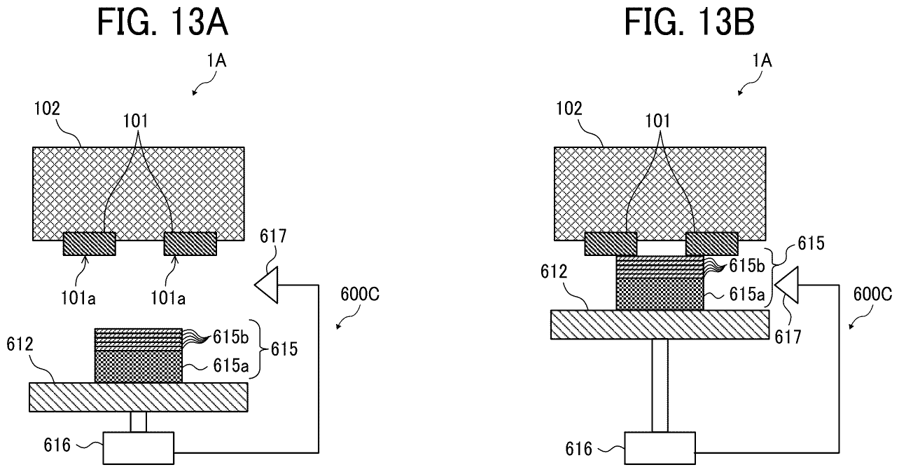

For example, FIGS. 13A and 13B illustrate a printer 1A that includes a head cleaner 600C as a modification example of the head cleaner 600B. The head cleaner 600C includes a sensor 617 and a driver 616. The sensor 617 detects the height of the uppermost wiper sheet 615b. Based on a detection result of the sensor 617 (e.g., a time when the uppermost wiper sheet 615b passes through a detection position of the sensor 617), the driver 616 lifts the slider 612 and the wiper 615 and adjusts a position of the wiper 615 that is lifted.

Each of the head cleaner 600 according to the first embodiment, the head cleaner 600A as the modification example of the head cleaner 600, the head cleaner 600B according to the second embodiment, and the head cleaner 600C as the modification example of the head cleaner 600B is removably installed in the liquid discharge apparatus, that is, the printer 1 or 1A that prints on cloth serving as a liquid application target. However, each of the head cleaners 600, 600A, 600B, and 600C may be removably installed in other apparatuses such as a liquid discharge apparatus that discharges liquid onto a sheet serving as a liquid application target.

The liquid discharge apparatus applied with the technology of the present disclosure defines an apparatus that includes a liquid discharge head or a liquid discharge unit and drives the liquid discharge head to discharge liquid. The liquid discharge apparatus encompasses an apparatus that discharges liquid onto a target to be adhered with liquid and an apparatus that discharges liquid into air or liquid.

The liquid discharge apparatus also encompasses an apparatus that feeds, conveys, and outputs a target that is to be adhered with or is adhered with liquid, a pre-processing apparatus, a post-processing apparatus (e.g., a finisher), and the like.

For example, the liquid discharge apparatus is an image forming apparatus that discharges ink onto a sheet, thus forming an image on the sheet, a three-dimensional modeling apparatus that discharges modeling liquid to powder layers formed with powder in layer forms, thus fabricating a three-dimensional object, or the like.

The liquid discharge apparatus is not limited to an apparatus that discharges liquid to form a visible image having meaning such as characters and figures. For example, the liquid discharge apparatus also includes an apparatus that forms an image not having meaning such as patterns or fabricates a three-dimensional image.

The target to be adhered with liquid defines an object to be adhered with liquid at least temporarily. The object is adhered and fixed with liquid or is adhered and permeated with liquid. For example, the target to be adhered with liquid includes recording media such as a sheet, recording paper, a recording sheet, film, and cloth, electronic components such as an electronic substrate and a piezoelectric element, and media such as a powder layer, an organ model, and an inspection cell. The target to be adhered with liquid includes any object to be adhered with liquid unless otherwise specified.

The target to be adhered with liquid is made of a material to be adhered with liquid at least temporarily, such as paper, thread, fabric, cloth, leather, metal, plastics, glass, wood, and ceramics.

The liquid has viscosity and surface tension with which the liquid is discharged from the liquid discharge head and is not limited. The liquid preferably has viscosity not greater than 30 mPa·s under normal temperature and normal pressure or by heating or cooling. For example, the liquid includes solution, suspension, emulsion, or the like that contains a solvent such as water and an organic solvent, a colorant such as dye and pigment, a functional material such as a polymerizable compound, resin, and a surfactant, a biocompatible material such as deoxyribonucleic acid (DNA), amino acid, protein, and calcium, an edible ingredient such as natural pigment, or the like. For example, the liquid is used as ink for inkjet printing, surface treatment liquid, liquid for forming components of an electronic element and a light-emitting element, liquid for forming an electronic circuit resist pattern, liquid for fabricating a three-dimensional object, and the like.

The liquid discharge apparatus defines an apparatus that moves the liquid discharge head relative to the target to be adhered with liquid. However, the liquid discharge apparatus may have other configurations. For example, the liquid discharge apparatus may be a serial type apparatus that moves the liquid discharge head, a line type apparatus that does not move the liquid discharge head, or the like.

The liquid discharge apparatus may be a treatment solution application apparatus that discharges a treatment solution onto a sheet to apply the treatment solution on a surface of the sheet so as to achieve an objective such as reforming the surface of the sheet. The liquid discharge apparatus may be a jet-granulation apparatus that jets composition liquid dispersed with ingredients in a solution through a nozzle to fabricate minute particles of the ingredients.

The embodiments described above are examples and achieve advantages particular to aspects described below, respectively.

A description is provided of a first aspect of the embodiments of the present disclosure.

As illustrated in FIGS. 4 and 5, a head cleaner (e.g., the head cleaners 600, 600A, 600B, and 600C) according to the first aspect includes a wiper (e.g., the wipers 611, 611A, and 615), a support (e.g., the slider 612), and a securing member (e.g., the sheet holder 613). The support supports the wiper. The wiper wipes and cleans a nozzle face (e.g., the nozzle face 101a) of a liquid discharge head (e.g., the liquid discharge head 101). The wiper includes a wiping portion (e.g., the wiper sheets 611b and 615b) and a flexible presser (e.g., the flexible pressers 611a, 611aA, and 615a). The wiping portion contacts and wipes the nozzle face. The flexible presser has a flexibility greater than a flexibility of the nozzle face. The flexible presser presses the wiping portion against the nozzle face. The securing member removably secures the wiping portion to the flexible presser such that the wiping portion is removed for replacement.

A description is provided of a construction of a comparative head cleaner.

The comparative head cleaner is attached to a guide that moves and guides a carriage mounting a liquid discharge head reciprocatingly. The comparative head cleaner includes a slider and a wiper. The slider serving as a support is held by a holder such that the slider slides in a direction perpendicular to an axial direction of the guide. The wiper is attached to the slider such that the wiper is replaceable. While the comparative head cleaner cleans a nozzle face of the liquid discharge head, the holder is attached to the guide that supports the carriage and the wiper contacts the nozzle face of the liquid discharge head mounted on the carriage. Thereafter, a user manually moves and slides the slider over the holder. Accordingly, the wiper moves relative to the nozzle face. Thus, the wiper wipes and cleans the nozzle face of the liquid discharge head.

Since the comparative head cleaner incorporates the wiper that is supported by the support such that the wiper is replaceable, the comparative head cleaner may increase replacement costs for replacing the wiper as a replacement part and may increase maintenance costs of a liquid discharge apparatus employing the comparative head cleaner.

The wiper that contacts and wipes the nozzle face of the liquid discharge head has a sufficient thickness and is more flexible than the nozzle face so as to wipe the nozzle face without damaging the nozzle face. For example, in order to clean the nozzle face with the wiper impregnated with a cleaning solution to remove stains adhered to the liquid discharge head, the comparative head cleaner incorporates the wiper made of sponge that retains a sufficient amount of the cleaning solution. The wiper having the sufficient thickness and flexibility may increase costs. After the wiper is used to clean the nozzle face, a wiping face of the wiper is adhered with stains from the nozzle face. Accordingly, when the wiper is used again, the wiper may stain the nozzle face. Hence, in order to maintain a proper condition of the liquid discharge apparatus, the wiper is preferably replaced with new one once the wiper is used. However, the wiper as a replacement part may increase costs as described above, increasing maintenance costs of the liquid discharge apparatus.

With the head cleaner according to the first aspect, the wiper supported by the support is divided into the wiping portion and the flexible presser. The wiping portion contacts and wipes the nozzle face. The flexible presser is more flexible than the nozzle face and presses the wiping portion against the nozzle face. The wiping portion is secured to the flexible presser such that the wiping portion is removable for replacement. Accordingly, while the flexible presser ensures flexibility for wiping the nozzle face without damaging the nozzle face, the wiping portion adhered with stains from the nozzle face is replaced as a replacement part. Hence, compared to a configuration in which an entirety of the wiper is replaced as a replacement part, the head cleaner according to the first aspect decreases costs for the replacement part (e.g., the wiping portion of the wiper), thus decreasing maintenance costs of a liquid discharge apparatus (e.g., the printers 1 and 1A).

A description is provided of a second aspect of the embodiments of the present disclosure.

Based on the first aspect, in the head cleaner according to the second aspect, the wiping portion covers a pressing face (e.g., the pressing faces 611a1, 611a1A, and 615a1) of the flexible presser. The wiping portion includes a wiper sheet (e.g., the wiper sheets 611b and 615b) that has a thickness smaller than a thickness of the flexible presser.

Accordingly, the head cleaner decreases costs of a replacement part (e.g., the wiping portion of the wiper), decreasing maintenance costs of the liquid discharge apparatus.

A description is provided of a third aspect of the embodiments of the present disclosure.

Based on the second aspect, in the head cleaner according to the third aspect, the wiper sheet includes an extension (e.g., the extension 611b2) that extends outboard from the pressing face of the flexible presser. The securing member switches between a securing state in which the securing member presses the extension against the support to secure the extension to the support and a replacement state in which the securing member releases pressure applied to the extension for replacement of the wiper sheet.

Accordingly, since the securing member switches between the securing state and the replacement state, the securing member allows a user to replace the wiper sheet with new wiper sheet and secure the new wiper sheet to the support, facilitating replacement of the wiper sheet.

A description is provided of a fourth aspect of the embodiments of the present disclosure.

As illustrated in FIG. 10, based on any one of the first aspect to the third aspect, in the head cleaner according to the fourth aspect, the pressing face of the flexible presser includes a projection (e.g., the projection 611p) that presses against the wiper sheet and a depression (e.g., the depression 611d) that is depressed with respect to the projection.

Accordingly, the projection of the pressing face of the flexible presser locally contacts and presses against the wiping portion with increased pressure, causing the wiping portion to scrape stains from the nozzle face of the liquid discharge head. Thus, the pressing face improves cleaning performance of the head cleaner.

A description is provided of a fifth aspect of the embodiments of the present disclosure.

As illustrated in FIGS. 11, 12, 13A, and 13B, a head cleaner (e.g., the head cleaners 600B and 600C) according to the fifth aspect includes a support (e.g., the slider 612) and a wiper (e.g., the wiper 615) that is supported by the support and wipes and cleans the nozzle face of the liquid discharge head. The wiper includes a plurality of wiping portions (e.g., the wiper sheets 615b) and a flexible presser (e.g., the flexible presser 615a). The plurality of wiping portions includes a first wiping portion (e.g., the wiper sheet 615b) that contacts and wipes the nozzle face and a second wiping portion (e.g., the wiper sheet 615b) that is attached with the first wiping portion and is disposed below the first wiping portion. The flexible presser has a flexibility greater than a flexibility of the nozzle face and presses the first wiping portion and the second wiping portion against the nozzle face. The flexible presser has a pressing face (e.g., the pressing face 615a1) that mounts the first wiping portion layered on the second wiping portion. The first wiping portion is peeled off from the second wiping portion.

In the head cleaner according to the fifth aspect also, the wiper supported by the support is divided into the plurality of wiping portions and the flexible presser. The plurality of wiping portions includes the first wiping portion that contacts and wipes the nozzle face. The flexible presser is more flexible than the nozzle face and presses the first wiping portion and the second wiping portion against the nozzle face. The first wiping portion and the second wiping portion are secured to the flexible presser such that the first wiping portion is replaced with respect to the flexible presser. Accordingly, the flexible presser ensures flexibility that causes the first wiping portion to wipe the nozzle face without damaging the nozzle face. The first wiping portion that is adhered with stains from the nozzle face is replaced with new one (e.g., the second wiping portion) as a replacement part. Hence, compared to a configuration in which an entirety of the wiper is replaced with new one as a replacement part, the head cleaner decreases costs of the replacement part (e.g., the first wiping portion of the wiper), decreasing maintenance costs of the liquid discharge apparatus.

Additionally, the head cleaner according to the fifth aspect eliminates the securing member incorporated in the head cleaner according to the first aspect, attaining a simple construction.

Further, in the head cleaner according to the fifth aspect, the first wiping portion serving as an uppermost wiping portion of the plurality of wiping portions that is layered is peeled off, attaining removal of the first wiping portion that is stained and setting of the second wiping portion that is clean at a time. Thus, the head cleaner according to the fifth aspect simplifies replacement of the first wiping portion.

A description is provided of a sixth aspect of the embodiments of the present disclosure.

Based on any one of the first aspect to the fifth aspect, in the head cleaner according to the sixth aspect, the flexible presser is mounted on the support and combined with the support.

Accordingly, since the flexible presser of the wiper serves as a non-replacement part, the head cleaner decreases costs for replacing a replacement part further, thus decreasing maintenance costs of the liquid discharge apparatus.

A description is provided of a seventh aspect of the embodiments of the present disclosure.

The liquid discharge apparatus (e.g., the printers 1 and 1A) according to the seventh aspect includes the liquid discharge head (e.g., the liquid discharge head 101) and the head cleaner (e.g., the head cleaners 600, 600A, 600B, and 600C) according to any one of the first aspect to the sixth aspect, that cleans the nozzle face (e.g., the nozzle face 101a) of the liquid discharge head.

Accordingly, the liquid discharge apparatus decreases maintenance costs.

According to the embodiments described above, each of the printers 1 and 1A serves as the liquid discharge apparatus. Alternatively, the liquid discharge apparatus may be a copier, a facsimile machine, a multifunction peripheral (MFP) having at least two of copying, printing, scanning, facsimile, and plotter functions, or the like.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A head cleaner for cleaning a nozzle face of a liquid discharge head, the head cleaner comprising:
a wiper to wipe and clean the nozzle face,
the wiper including:
a wiping portion to contact and wipe the nozzle face; and
a flexible presser to press the wiping portion against the nozzle face, the flexible presser having a flexibility greater than a flexibility of the nozzle face;
a support supporting the wiper; and
a securing member to secure the wiping portion to the flexible presser removably.

2. The head cleaner according to claim 1,
wherein the flexible presser includes a porous material.

3. The head cleaner according to claim 1,
wherein the flexible presser has a pressing face that is covered by the wiping portion, and
wherein the wiping portion includes a wiper sheet that has a thickness smaller than a thickness of the flexible presser.

4. The head cleaner according to claim 3,
wherein the wiper sheet includes an extension extending outboard from the pressing face of the flexible presser, and
wherein the securing member switches between a securing state in which the securing member presses the extension against the support to secure the extension to the support and a replacement state in which the securing member releases pressure applied to the extension.

5. The head cleaner according to claim 4, further comprising a hinge mounted on the support,
wherein the securing member pivots about the hinge.

6. The head cleaner according to claim 3,
wherein the pressing face of the flexible presser includes:
a projection to press against the wiper sheet; and
a depression depressed with respect to the projection.

7. The head cleaner according to claim 1,
wherein the flexible presser is mounted on the support and combined with the support.

8. The head cleaner according to claim 1,
wherein the securing member includes a frame.

9. A head cleaner for cleaning a nozzle face of a liquid discharge head, the head cleaner comprising:
a wiper to wipe and clean the nozzle face; and
a support supporting the wiper,
the wiper including:
a first wiping portion to contact and wipe the nozzle face;
a second wiping portion attached with the first wiping portion removably; and
a flexible presser to press the first wiping portion and the second wiping portion against the nozzle face, the flexible presser having a flexibility greater than a flexibility of the nozzle face,
the first wiping portion to peel off from the second wiping portion.

10. The head cleaner according to claim 9,
wherein the second wiping portion is disposed below the first wiping portion, and
wherein the flexible presser has a pressing face mounting the first wiping portion layered on the second wiping portion.

11. The head cleaner according to claim 9, further comprising:
a driver to move the wiper and the support; and
a sensor to detect the first wiping portion of the wiper.

12. A liquid discharge apparatus comprising:
a liquid discharge head having a nozzle face to discharge liquid; and
a head cleaner to clean the nozzle face,
the head cleaner including:
a wiper to wipe and clean the nozzle face,
the wiper including:
a wiping portion to contact and wipe the nozzle face; and
a flexible presser to press the wiping portion against the nozzle face, the flexible presser having a flexibility greater than a flexibility of the nozzle face;
a support supporting the wiper, and
a securing member to secure the wiping portion to the flexible presser removably.
